(19) United States
(12) Patent Application Publication
(10) Pub. No.: US 2013/0276266 A1
(43) Pub. Date: Oct. 24, 2013

(54) UNIVERSAL HINGE

(71) Applicant: Eric Dempsey Pendarvis, Prairieville, LA (US)

(72) Inventor: Eric Dempsey Pendarvis, Prairieville, LA (US)

(21) Appl. No.: 13/451,520

(22) Filed: Apr. 19, 2012

(51) Int. Cl. E05D 1/00; B23P 6/00

(52) U.S. Cl. 16/225; 29/402.08

(57) ABSTRACT

A durable, two-ply rubber-reinforced hinge is designed to bend an indefinite amount of times, thereby solving the problem of breaking or tearing that occurs in conventional plastic hinges. The hinges of the present invention may be particularly suited for use with ice chests/portable coolers—either at the original hinge at the time of manufacture, or as a replacement hinge when the original hinges break.

### BACKGROUND OF THE INVENTION

The present invention relates to universal hinge and, more particularly, to a durable two-ply reinforced hinge suitable for use with portable coolers.

Factory ice chest hinges break due to their hard plastic material. Since hard plastic is limited to the number of bends it can make before it breaks, factory hinges are designed to have a short lifespan.

Moreover, should an existing portable cooler hinge break, it is difficult to find the correct replacement hinge, as existing hinges are model specific.

As can be seen, there is a need for an improved hinge for a portable cooler that may withstand multiple bends without breaking or tearing.

### SUMMARY OF THE INVENTION

In one aspect of the present invention, a hinge comprises first and second hinge plates; a plurality of holes formed in each of the first and second hinge plates; and a flexible material adapted to extend from behind the first hinge plate to behind the second hinge plate with a bend area therebetween.

In another aspect of the present invention, a hinge comprises first and second hinge plates; a plurality of holes formed in each of the first and second hinge plates; a reinforced rubber material adapted to extend from behind the first hinge plate to behind the second hinge plate with a bend area therebetween; and a plurality of screw holes in the reinforced rubber material, the screw holes aligning with the plurality of holes in each of the first and second hinge plates.

In a further aspect of the present invention, a method for replacing a broken hinge from a container with a hinged lid with a replacement hinge comprises removing the broken hinge; inserting a plurality of fasteners through holes in a first hinge plate and through holes in a reinforced rubber material disposed behind the first hinge plate; securing the first hinge plate to the lid; inserting a plurality of fasteners through holes in a second hinge plate and through holes in the reinforced rubber material disposed behind the second hinge plate; providing a bend area of the reinforced rubber material in between the container and the lid; and securing the second hinge plate to the container.

These and other features, aspects and advantages of the present invention will become better understood with reference to the following drawings, description and claims.

### BRIEF DESCRIPTION OF THE DRAWINGS

FIG. 1 is a perspective view of a hinged container having a universal hinge according to an exemplary embodiment of the present invention;

FIG. 2 is a close-up perspective view of the universal hinge of FIG. 1, attached to the container;

FIG. 3 is a perspective view of the universal hinge of FIG. 1;

FIG. 4 is a perspective view of the universal hinge of FIG. 1 being bent in a first direction;

FIG. 5 is a perspective view of the universal hinge of FIG. 1 being bent in a second direction;

FIG. 6 is a close-up perspective view of the universal hinge of FIG. 1, attached to a hinged container, being opened;

FIG. 7 is a front perspective exploded view of the universal hinge of FIG. 1;

FIG. 8 is a back perspective exploded view of the universal hinge of FIG. 1;

FIG. 9 is a cross-sectional view taken along line 9-9 of FIG. 2; and

FIG. 10 is a cross-sectional view taken along line 10-10 of FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a durable, two-ply rubber-reinforced hinge that is designed to bend an indefinite amount of times, thereby solving the problem of breaking or tearing that occurs in conventional plastic hinges. The hinges of the present invention may be particularly suited for use with ice chests/portable coolers—either at the original hinge at the time of manufacture, or as a replacement hinge when the original hinges break.

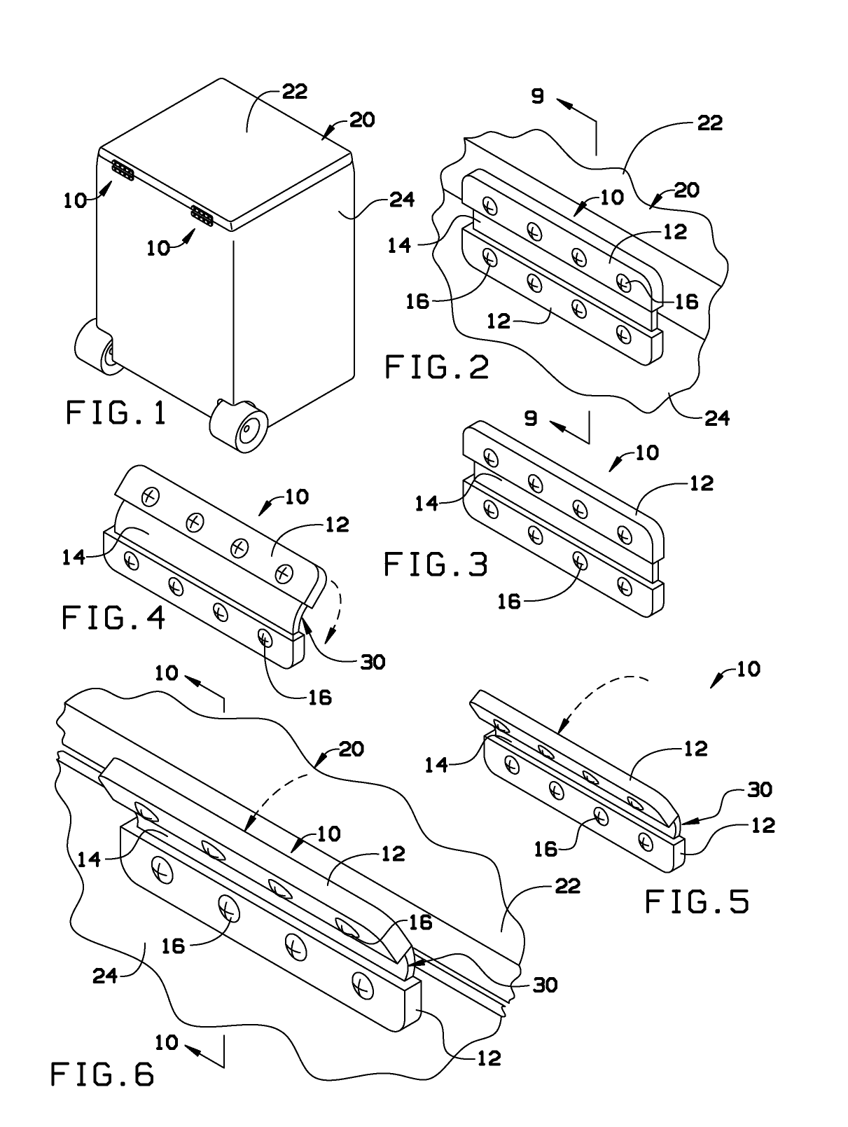

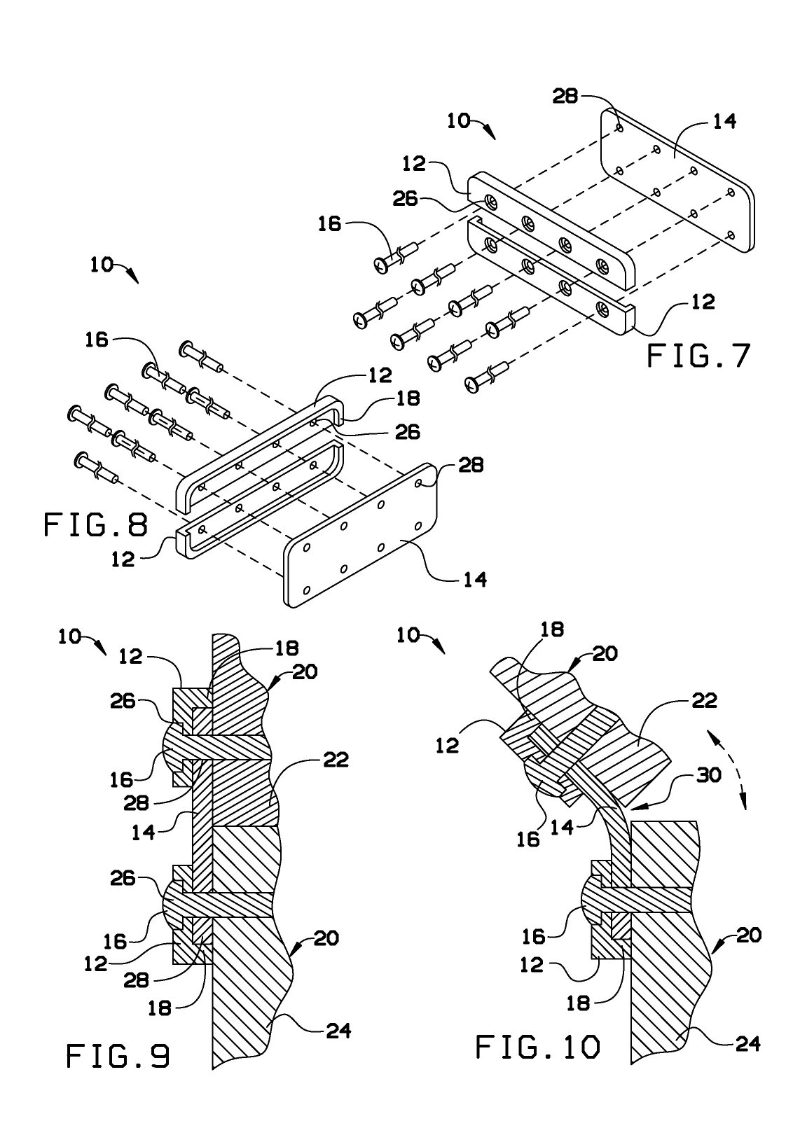

Referring now to FIGS. 1 through 10, a hinge 10 (also referred to as a universal hinge 10) may include first and second hinge plates 12 with a flexible material 14 spanning between the hinge plates 12. The hinge plates 12 may be flat plates or may include a lip 18 about three sides of its outer periphery (each side except the side from which the flexible material 14 extends out therefrom). The hinge plates 12 may be made from various materials, including plastic, metal, such as stainless steel, composite, and the like. The hinge plates 12 may be from about 2 inches to about 6 inches long and from about ½ inch to about 1.5 inches wide, for example.

The hinge plates 12 may include a plurality of holes 26 formed therein to pass fasteners 16 through. For example, four holes 26 may be formed along the length of each of the hinge plates 12. The holes 26 may be counter bored holes to permit the fasteners 16 to be flush or near-flush mounted in the plates 12. The fasteners 16 may be, for example, screws, such as stainless steel pan head screws.

The flexible material 14 may be a reinforced rubber material, from about 0.1 inch to about 0.3 inch thick, for example, typically about ⅛ inch thick. The thickness of the flexible material 14 may correspond with the thickness of the lip 18. The flexible material 14 may provide a bend area 30 that allows the hinge 10 to bend. The flexible material 14 may include screw holes 28 along each side thereof. The screw holes 28 may align with the holes 26 in the hinge plates 12. The flexible material 14 may be sized to fit behind each of the hinge plates 12 with a space from about ¼ inch to about 1 inch in between. This space can act as the bend area 30 of the hinge 10.

The first hinge plate 12 may be attached to, for example, a lid 22 of a portable cooler 20. The second hinge plate 14 may be attached to the base 24 of the cooler 20, where the flexible material 14 spans between the lid 22 and the base 24, allowing the lid 22 to open and close.

The hinge 10 of the present invention may be useful as a replacement hinge when a hinge on a portable cooler or ice chest breaks or tears. In this embodiment, a user can simply remove the broken hinge and attach the hinge 10 of the present invention in its place. The replacement hinge 10 may be positioned in the area where the broken hinge was removed, covering any old screw holes or attachment areas from the broken hinge.

While the above discusses using the hinge 10 for a portable cooler or ice chest, the hinge of the present invention may be useful in various other applications. For example, the hinge 10 may be useful as a replacement hinge for virtually any lid, such as tackle boxes, gun cases, tool boxes and the like.

It should be understood, of course, that the foregoing relates to exemplary embodiments of the invention and that modifications may be made without departing from the spirit and scope of the invention as set forth in the following claims.

What is claimed is:

1. A hinge comprising:
first and second hinge plates;
a plurality of holes formed in each of the first and second hinge plates; and
a flexible material adapted to extend from behind the first hinge plate to behind the second hinge plate with a bend area therebetween.

2. The hinge of claim 1, wherein the flexible material is a reinforced rubber material.

3. The hinge of claim 1, further comprising a plurality of screw holes in the flexible material, the screw holes aligning with the plurality of holes in each of the first and second hinge plates.

4. The hinge of claim 1, further comprising a lip disposed about three sides of a periphery of the first and second hinge plates.

5. The hinge of claim 1, wherein the plurality of holes are counter bored fastener holes.

6. A hinge comprising:
first and second hinge plates;
a plurality of holes formed in each of the first and second hinge plates;
a reinforced rubber material adapted to extend from behind the first hinge plate to behind the second hinge plate with a bend area therebetween; and
a plurality of screw holes in the reinforced rubber material, the screw holes aligning with the plurality of holes in each of the first and second hinge plates.

7. The hinge of claim 6, further comprising a lip disposed about three sides of a periphery of the first and second hinge plates.

8. The hinge of claim 6, wherein the plurality of holes are counter bored fastener holes.

9. A method for replacing a broken hinge from a container with a hinged lid with a replacement hinge, the method comprising:
removing the broken hinge;
inserting a plurality of fasteners through holes in a first hinge plate and through holes in a reinforced rubber material disposed behind the first hinge plate;
securing the first hinge plate to the lid;
inserting a plurality of fasteners through holes in a second hinge plate and through holes in the reinforced rubber material disposed behind the second hinge plate;
providing a bend area of the reinforced rubber material in between the container and the lid; and
securing the second hinge plate to the container.

10. The method of claim 9, further comprising using the replacement hinge to cover the area where the broken hinge was removed.
